(19) United States
(12) Patent Application Publication
(10) Pub. No.: US 2022/0066601 A1
(43) Pub. Date: Mar. 3, 2022

(54) METHOD AND APPARATUS FOR DISPLAYING TASK PICTURES

(71) Applicant: BEIJING DAJIA INTERNET INFORMATION TECHNOLOGY CO., LTD., Beijing (CN)

(72) Inventor: Songyu LIANG, Beijing (CN)

(21) Appl. No.: 17/462,137

(22) Filed: Aug. 31, 2021

(30) Foreign Application Priority Data
Sep. 1, 2020 (CN) 202010906870.0

(51) Int. Cl. G06F 3/0482; G06T 3/40; G06F 3/14; G06F 9/451

(52) U.S. Cl. CPC G06F 3/0482; G06T 3/40; G06T 2200/24; G06F 9/451; G06F 3/14

(57) ABSTRACT

A method for displaying task pictures is disclosed. The method includes: obtaining an instruction of displaying a task list page; obtaining a name for each task of at least one task to be displayed and at least one thumbnail corresponding to each task from a server based on the instruction of displaying the task list page, in which the at least one thumbnail is generated by the server based on at least one picture associated with each task; and displaying the name and the at least one thumbnail for each task at a display position corresponding to each task on the task list page.

### CROSS REFERENCE TO RELATED APPLICATIONS

This disclosure is based on and claim priority under 35 U.S.C. 119 to Chinese Patent Application No. 202010906870.0, filed on Sep. 1, 2020 in the China National Intellectual Property Administration, the disclosures of which are herein incorporated by reference in their entireties.

### TECHNICAL FIELD

The disclosure relates to the field of computer application technology, and more particularly to a method and an apparatus for displaying task pictures.

### BACKGROUND

At present, compared with conventional methods for paper-based task management, task management software has been widely used due to its ease of use, good reliability, and high work efficiency. The user may perform management affairs such as creating, querying and counting the tasks by the task management software. Sometimes, the user may need to upload task-related pictures to the software when creating the tasks.

### SUMMARY

According to a first aspect of the embodiments of the disclosure, a method for displaying task pictures includes: obtaining an instruction of displaying a task list page; obtaining a name for each task of at least one task to be displayed and at least one thumbnail corresponding to each task from a server based on the instruction of displaying the task list page, in which the at least one thumbnail is generated by the server based on at least one picture associated with each task; and displaying the name and the at least one thumbnail for each task at a display position corresponding to each task on the task list page.

According to a second aspect of the embodiments of the disclosure, a method for displaying task pictures includes: obtaining at least one picture associated with each task in a task list page; generating a thumbnail corresponding to each picture in the at least one picture; receiving an instruction of displaying a task list page sent by a client terminal; obtaining a name for each task of at least one task to be displayed and at least one thumbnail corresponding to each task from a server based on the instruction of displaying the task list page; and sending the name and the at least one thumbnail for each task of at least one task to the client terminal, so that the client terminal displays the name and the at least one thumbnail for each task at a display position corresponding to each task in the task list page.

According to a third aspect of the embodiments of the disclosure, an apparatus for displaying task pictures includes: a processor and a memory for storing instructions executable by the processor. The processor is configured to: obtain at least one picture associated with each task in a task list page; generate a thumbnail corresponding to each picture in the at least one picture; receive an instruction of displaying a task list page sent by a client terminal; obtain a name for each task of at least one task to be displayed and at least one thumbnail corresponding to each task from a server based on the instruction of displaying the task list page; and send the name and the at least one thumbnail for each task of at least one task to the client terminal, so that the client terminal displays the name and the at least one thumbnail for each task at a display position corresponding to each task in the task list page.

It should be understood that the above general description and the following detailed description are only exemplary and explanatory, without any limitations to the disclosure.

### BRIEF DESCRIPTION OF THE DRAWINGS

The drawings herein are incorporated into the specification and constitute a part of the specification, show embodiments in accordance with the disclosure, and are used to explain the principle of the disclosure together with the specification, which do not constitute an improper limitation to the disclosure.

FIG. 1 is a flow chart illustrating a method for displaying task pictures according to an embodiment of the disclosure.

FIG. 2 is a schematic diagram illustrating an interface display style of a task list page in a method for displaying task pictures according to an embodiment of the disclosure.

FIG. 3 is a flow chart illustrating displaying a preview picture in a method for displaying task pictures according to an embodiment of the disclosure.

FIG. 4 is a flow chart illustrating another method for displaying task pictures according to an embodiment of the disclosure.

FIG. 5 is a flow chart illustrating generating a thumbnail corresponding to a picture in a method for displaying task pictures according to an embodiment of the disclosure.

FIG. 6 is a schematic diagram illustrating performing symmetrical truncation on two ends of a picture in a width direction based on a first width threshold in a method for displaying task pictures according to an embodiment of the disclosure.

FIG. 7 is a flowchart illustrating sending a thumbnail to a client terminal in a method for displaying task pictures according to an embodiment of the disclosure.

FIG. 8 is a flowchart illustrating generating a preview picture corresponding to a picture in a method for displaying a task picture according to an embodiment of the disclosure.

FIG. 9 is a block diagram illustrating an apparatus for displaying task pictures according to an embodiment of the disclosure.

FIG. 10 is a block diagram illustrating another apparatus for displaying task pictures according to an embodiment of the disclosure.

FIG. 11 is a block diagram illustrating another apparatus for displaying task pictures according to an embodiment of the disclosure.

FIG. 12 is a block diagram illustrating an electronic device according to an embodiment of the disclosure.

### DETAILED DESCRIPTION

In order to make those skilled in the art better understand the technical solutions of the disclosure, the technical solutions in the embodiments of the disclosure will be clearly and thoroughly described with reference to the accompanying drawings.

It should be noted that the terms such as “first” and “second” in the specification, claims and the above-mentioned drawings of the disclosure are used to distinguish similar objects, and not necessarily used to describe a specific sequence or precedence order. It should be understood that the data used in this way may be interchanged under appropriate circumstances so that the embodiments of the disclosure described herein may be implemented in an order other than those illustrated or described herein. The implementations described in the example embodiments below do not represent all implementations consistent with the disclosure. Rather, they are merely examples of apparatuses and methods consistent with some aspects of the disclosure as detailed in the appended claims.

In the related art, most of the task-related pictures are only displayed on detail pages of the tasks. The user needs to enter the detail pages of the tasks to view the pictures associated with the tasks, which lead to low efficiency of obtaining the pictures.

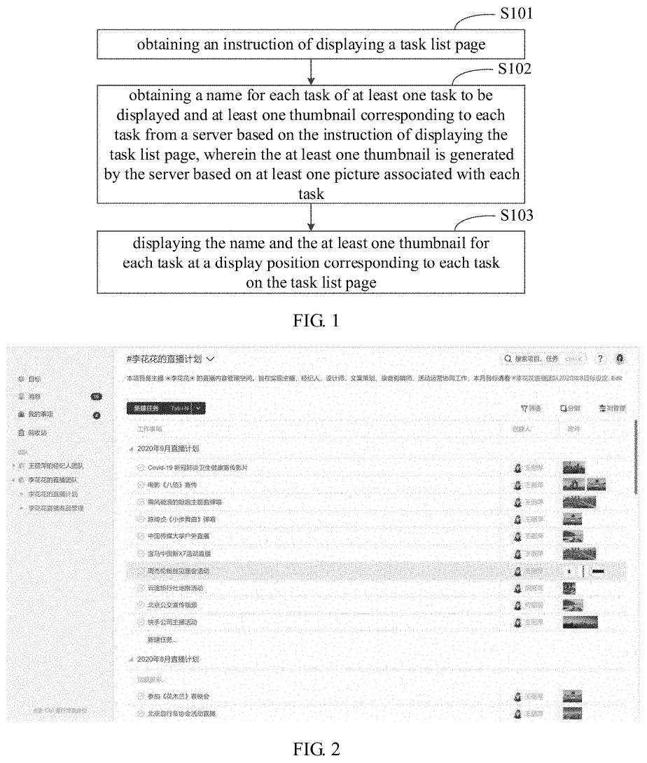

FIG. 1 is a flowchart illustrating a method for displaying task pictures according to an example embodiment. As illustrated in FIG. 1, the method for displaying task pictures is used in an electronic device and includes the following steps.

In S101, an instruction of displaying a task list page is obtained.

It should be noted that the execution subject of the method for displaying task pictures in the present disclosure is an electronic device. In an embodiment of the present disclosure, the method for displaying task pictures may be executed by an apparatus for displaying task pictures in the embodiment of the present disclosure. The apparatus for displaying task pictures may be configured in any electronic device to perform the method for displaying task pictures in the embodiment of the present disclosure.

In the embodiments of the present disclosure, the user may perform management affairs such as creating, querying and counting the tasks in the electronic device.

The electronic device includes but is not limited to a personal computer, a mobile terminal, etc., which is not too limited here.

In the embodiment of the present disclosure, the electronic device may display a task list page that is used to display basic information of tasks created by the user. The basic information of the task includes but is not limited to, a task name, a name of the user who created the task, the time when the task was created, a task start time, a file corresponding to the task, etc., which are not too limited here.

It may be understood that, the electronic device may monitor an instruction of displaying a task list page. When the user wants to open the task list page, the instruction of displaying the task list page may be sent via the electronic device.

In S102, a name for each task of at least one task to be displayed and at least one thumbnail corresponding to each task are obtained from a server based on the instruction of displaying the task list page. The at least one thumbnail is generated by the server based on at least one picture associated with each task.

In the embodiment of the present disclosure, the server stores the pictures associated with the task, and the server may generate the thumbnails based on the pictures associated with the task. It may be understood that, different tasks may be associated with different pictures, one task may be associated with one or more pictures, and different tasks may correspond to different thumbnails.

In the embodiment of the present disclosure, the task names correspond to the task thumbnails one by one. At least one thumbnail corresponding to each task may be determined based on the task name. Optionally, a correspondence between the task name and the thumbnails corresponding to each task may be preset in a storage space of the server for the electronic device to obtain.

Further, after obtaining the instruction of displaying the task list page, the electronic device sends an obtaining instruction to the server, so that the name for each task of the at least one task to be displayed and the at least one thumbnail corresponding to each task may be obtained from the server.

In S103, the name and at least one thumbnail for each task are displayed at a display position corresponding to each task on the task list page.

In specific implementation, the task list page may include a task list composed of multiple tasks for users to view, modify, and query. The name and at least one thumbnail for each task may be displayed in the task list.

For example, as illustrated in FIG. 2, the task list includes three parts: a task name, a creator, and an attachment, in which at least one thumbnail for each task may be displayed in the attachment.

The method for displaying task pictures according to the embodiment of the present disclosure may display task thumbnails on the task list page. Compared to only displaying the picture corresponding to the task on the task detail page in the related art, the user may obtain the task thumbnails on the task list page without entering into the task detail page again, which reduces a number of times of interactions and interaction duration for the user to obtain the pictures. Furthermore, the efficiency of obtaining the pictures is high based on the advantages of small space occupation and fast speed loading of the thumbnails, and the user's experience is improved.

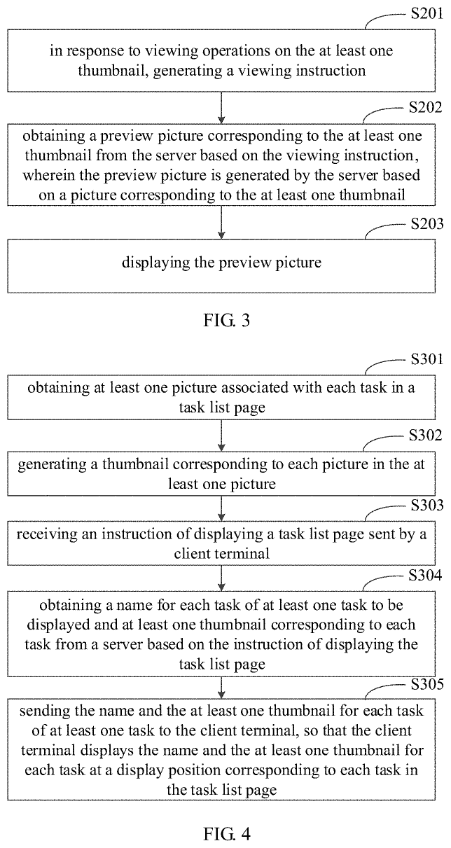

Based on any of the foregoing embodiments, as illustrated in FIG. 3, displaying the name and the at least one thumbnail for each task at the display position corresponding to each task on the task list page in S103, the method may include the following steps.

In S201, in response to viewing operations on the at least one thumbnail, a viewing instruction is generated.

In the embodiment of the present disclosure, the user may perform viewing operations on the at least one thumbnail in the task list page on the electronic device. The electronic device may generate the viewing instruction in response to the viewing operations on the at least one thumbnail.

In specific implementation, the viewing operations on the at least one thumbnail include, but are not limited to, moving a mouse to the at least one thumbnail, clicking or double-clicking the at least one thumbnail, etc., which are not too limited here.

In S202, a preview picture corresponding to the at least one thumbnail is obtained from the server based on the viewing instruction. The preview picture is generated by the server based on a picture corresponding to the at least one thumbnail.

In the embodiment of the present disclosure, the server may generate the preview picture corresponding to the at least one thumbnail based on the picture corresponding to the at least one thumbnail, and the generated preview picture may be preset in the storage space of the server for the electronic device to obtain.

Further, after the electronic device sends the generated viewing instruction, it may obtain the preview picture corresponding to the at least one thumbnail from the server.

In S203, the preview picture is displayed.

It may be understood that, if the user has viewing operations on the at least one thumbnail, which indicates that the user has a willingness to view the preview picture corresponding to the at least one thumbnail, the electronic device may display the preview picture to the user after obtaining the preview picture corresponding to the at least one thumbnail.

Therefore, the method may display the preview picture to the user based on the viewing operations of the user on the at least one thumbnail.

FIG. 4 is a flowchart illustrating another method for displaying task pictures according to an example embodiment. As illustrated in FIG. 4, the method for displaying task pictures is used in a server and includes the following steps.

In S301, at least one picture associated with each task in a task list page is obtained.

It should be noted that the execution subject of the method for displaying task pictures in the present disclosure is s server. The method for displaying task pictures in the embodiment of the present disclosure may be executed by an apparatus for displaying task pictures in the embodiment of the present disclosure. The apparatus for displaying task pictures may be configured in any server to perform the method for displaying task pictures in the embodiment of the present disclosure.

In the embodiment of the present disclosure, the user may upload the picture associated with the task to the server. It may be understood that, different tasks may be associated with different pictures, and one task may be associated with one or more pictures. Furthermore, the server may obtain at least one picture associated with each task in the task list page.

In S302, a thumbnail corresponding to each picture in at least one picture is generated.

In specific implementation, there are many ways to generate the thumbnails corresponding to the pictures, which are not too limited here.

In S303, an instruction of displaying a task list page sent by the client is received.

In an embodiment, the client terminal may be the aforementioned electronic device, or may be the apparatus for displaying task pictures mentioned in the embodiment illustrated in FIG. 1, in which the apparatus is loaded in the electronic device.

In S304, a name for each task of at least one task to be displayed and at least one thumbnail corresponding to each task are obtained from a server based on the instruction of displaying the task list page.

In the embodiment of the present disclosure, information on each task to be displayed is carried in the instruction of displaying the task list page. The server may obtain the name for each task of at least one task to be displayed and at least one thumbnail corresponding to each task based on the instruction of displaying the task list page.

In the embodiment of the present disclosure, there is a one-to-one correspondence between the name of the task and the at least one thumbnail corresponding to the task. The at least one thumbnail corresponding to the task may be determined based on the name of the task.

Optionally, the correspondence between the name of the task and the at least one thumbnail corresponding to the task may be preset in the storage space of the server.

In S305, the name and at least one thumbnail for each task of at least one task are sent to the client terminal, so that the client terminal displays the name and the at least one thumbnail for each task at a display position corresponding to each task in the task list page.

Regarding the specific implementation and principles of S301-S305, reference may be made to the detailed description in the foregoing embodiment, which will not be repeated here.

According to the method for displaying task pictures in the embodiments of the present disclosure, the server may generate thumbnails corresponding to the pictures, receive the instruction of displaying the task list page sent by the client terminal, and send the name and the at least one thumbnail for each task of at least one task to the client terminal, so that the client terminal displays the thumbnails of the task on the task list page. Compared to only displaying the thumbnails corresponding to the task on a task detail page in the related art, the user may obtain the thumbnails of the task on the task list page without entering the task detail page again, which reduces the number of interactions and the interaction duration of obtaining pictures. Further, based on the advantages of small space occupation and fast loading speed of thumbnails, the efficiency of obtaining pictures is high and the user experience is improved.

Based on any of the foregoing embodiments, as illustrated in FIG. 5, generating a thumbnail corresponding to the picture in S302 may include the following steps.

In S401, a size of each picture is obtained.

It may be understood that, the size of each picture is a basic parameter, which may be obtained by reading attribute parameters of the picture. The size includes but is not limited to information such as a height and a width of the picture.

In S402, a display mode of the thumbnail corresponding to each picture is determined based on the size of each picture.

In the embodiments of the present disclosure, considering the influence of the picture size on the display mode, different picture sizes may correspond to different display modes.

In specific implementation, a mapping relationship or a mapping table between picture sizes and display modes of the thumbnail may be established in advance. After the picture size is obtained, the required display mode of the thumbnail may be obtained by querying the mapping relationship or the mapping table. It should be noted that the above-mentioned mapping relationship or mapping table may be calibrated according to actual conditions and set in the storage space of the server in advance.

In S403, each picture is processed based on the display mode of the thumbnail to generate the thumbnail.

Therefore, considering the influence of the picture size on generating the thumbnail, the display mode of the thumbnail in the method may be determined based on the picture size, and each picture is processed based on the display mode to generate the thumbnail corresponding to the picture.

Further, determining the display mode of the thumbnail corresponding to each picture based on the size of each picture in S402 may include any one or combination of the following two possible implementation manners:

Manner 1, when the width of each picture is equal to or less than a preset first width threshold or the height of each picture is equal to or less than a preset first height threshold, a display mode in a first preset picture box is determined as the display mode of the thumbnail.

The first width threshold, the first height threshold, and a width and a height of the first preset picture box may be set according to actual conditions, and preset in the storage space of the server. For example, the first width threshold, the first height threshold, and the width and height of the first preset picture box can all be set to 30 px (pixel). It should be noted that the px is a relative length unit.

In the embodiments of the present disclosure, when the width of each picture is equal to or less than the preset first width threshold or the height of each picture is equal to or less than the preset first height threshold, it indicates that the width and/or height of each picture is small, the display mode in the first preset picture box may be determined as the display mode of the thumbnail according to a display rule for the minimum size. The display mode in the first preset picture box refers to a display mode where the thumbnail is displayed in the first preset picture box and a display area of the thumbnail does not exceed the first preset picture box. The specific display mode is not limited here.

It may be understood that, for the thumbnail obtained by the display mode in the first preset picture box, its width is less than or equal to the width of the first preset picture box and its height is less than or equal to the height of the first preset picture box.

Further, when the display mode of the thumbnail is the display mode in the first preset picture box, processing each picture based on the display mode of the thumbnail to generate the thumbnail in S403 may include three possible implementation manners below.

As a first possible implementation manner, when the width of each picture is equal to or less than the first width threshold and the height of each picture is equal to or less than the first height threshold, each picture is displayed in the first preset picture box in a horizontally and vertically centered manner, to generate the thumbnail.

It should be noted that the width of the first preset picture box is the first width threshold, and the height of the first preset picture box is the first height threshold.

In the embodiments of the present disclosure, when the width of each picture is equal to or less than the first width threshold and the height of each picture is equal to or less than the first height threshold, it indicates that the width of each picture is equal to or less than the width of the first preset picture box and the height of each picture is also equal to or less than the height of the first preset picture box, the width and height of each picture may be kept unchanged at this time, and each picture is displayed in the first preset picture box in a horizontally and vertically centered manner to generate the thumbnail corresponding to the picture.

As a second possible implementation manner, when the width of each picture is greater than the first width threshold and the height of each picture is equal to or less than the first height threshold, two ends of each picture is symmetrically truncated in a width direction based on the first width threshold, and the truncated picture is displayed in the first preset picture box in a horizontally and vertically centered manner to generate the thumbnail.

In the embodiments of the present disclosure, when the width of each picture is greater than the first width threshold and the height of each picture is equal to or less than the first height threshold, it indicates that the width of each picture is greater than the width of the first preset picture box and the height of each picture is equal to or less than the height of the first preset picture box, two ends of each picture at this time may be truncated symmetrically in the width direction based on the first width threshold, so that the width of the truncated picture is less than or equal to the first width threshold while maintaining the height of each picture unchanged, and the truncated picture is displayed in the first preset picture box in a horizontally and vertically centered manner to generate the thumbnail corresponding to the picture.

Symmetrically truncating two ends of each picture in the width direction based on the first width threshold may be illustrated by the following examples.

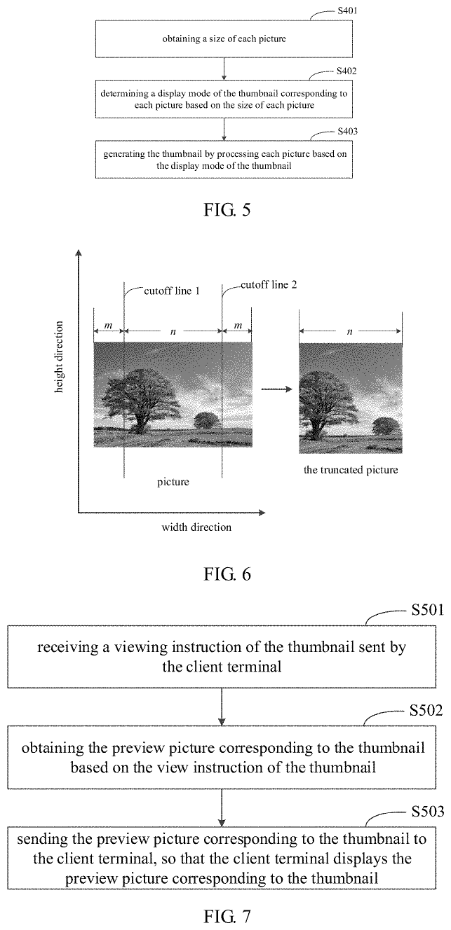

In specific implementation, as illustrated in FIG. 6, the width and height directions of the picture are shown. Assuming that the width of the picture is greater than the first width threshold and the height of the picture is less than the first height threshold, the picture may be truncated along cutoff lines 1, 2 in the width direction at this time. The direction of cutoff lines 1, 2 is consistent with the height direction and a distance n between the cutoff lines 1, 2 in the width direction is equal to or less than the first width threshold, in which the distance n is also equal to the width of the truncated picture. The cutoff line 1 has a distance m away from the relatively close side of the picture in the width direction, which is the same as the distance of the cutoff line 2 away from the opposite side of the picture. In this way, it may be achieved that two ends of each picture is symmetrically truncated in the width direction.

m may be calculated by the following formula:

$$m = \frac{picture \text{width-width} of the truncated picture}{2}$$

It may be understood that, the distance of the cutoff line 1 or 2 to the relatively close side the picture in the width direction may be calculated based on the width of each picture and the width of the truncated picture, to obtain the positions of the cutoff lines 1 and 2.

As a third possible implementation manner, when the width of each picture is equal to or less than the first width threshold and the height of each picture is greater than the first height threshold, two ends of each picture is symmetrically truncated in a height direction based on the first height threshold, and the truncated picture is displayed in the first preset picture box in a horizontally and vertically centered manner to generate the thumbnail.

In the embodiment of the present disclosure, when the width of each picture is equal to or less than the first width threshold and the height of each picture is greater than the first height threshold, it indicates that the width of each picture is equal to or less than the width of the first preset picture box and the height of each picture is greater than the height of the first preset picture box, two ends of each picture at this time may be truncated symmetrically in the height direction based on the first height threshold, so that the height of the truncated picture is less than or equal to the first height threshold while maintaining the width of each picture unchanged, and the truncated picture is displayed in the first preset picture box in a horizontally and vertically centered manner to generate the thumbnail corresponding to the picture.

It should be noted that, the specific implementation and principle of symmetrically truncating two ends of each picture in the height direction based on the first height threshold may be referred to the detailed description of symmetrically truncating two ends of each picture in the width direction based on the first width threshold, which will not be repeated here.

Manner 2: when the width of each picture is greater than the first width threshold and the height of each picture is greater than the first height threshold, a display mode in a first fixed aspect ratio is determined as the display mode of the thumbnail.

In the embodiment of the present disclosure, when the width of each picture is greater than the first width threshold and the height of each picture is greater than the first height threshold, it indicates that the width and height of the picture are both large, the display mode in the first fixed aspect ratio may be determined as the display mode of the thumbnail. The display mode in the first fixed aspect ratio refers to a display mode where the aspect ratio of the thumbnail is consistent with the aspect ratio of the picture.

Further, when the method for generating the thumbnail is the display method in the first fixed aspect ratio, processing each picture based on the display mode of the thumbnail to generate the thumbnail in S403 may include compressing the height and width of each picture in the same compression ratio to obtain the thumbnail, the height of which is the first height threshold.

At this time, the calculation method of the compression ratio p is as follows:

$$p = \frac{picture height}{first height threshold}$$

Therefore, the height of the thumbnail obtained by this method is the first height threshold, and the aspect ratio of the thumbnail is consistent with the aspect ratio of the picture.

Based on any of the foregoing embodiments, the server may also pre-store a preview picture corresponding to each picture in the at least one picture. Further, as illustrated in FIG. 7, after the name and the at least one thumbnail for each task of at least one task is sent to the client terminal in S305, the method may include the following steps.

In S501, a viewing instruction of the thumbnail sent by the client terminal is received.

In S502, the preview picture corresponding to the thumbnail is obtained based on the view instruction of the thumbnail.

In the embodiment of the present disclosure, thumbnail information is carried in the view instruction of the thumbnail, and the server may obtain the preview picture corresponding to the thumbnail based on the view instruction of the thumbnail.

In the embodiment of the present disclosure, there is a one-to-one correspondence between thumbnails and preview pictures, and a corresponding relationship between thumbnails and preview pictures may be preset in the storage space of the server.

In S503, the preview picture corresponding to the thumbnail is sent to the client terminal, so that the client terminal displays the preview picture corresponding to the thumbnail.

Thus, the server may generate the preview picture corresponding to the thumbnail, receive the viewing instruction of the thumbnail sent by the client terminal and send the preview picture corresponding to the thumbnail to the client terminal, so that the client terminal displays the preview picture corresponding to the thumbnail.

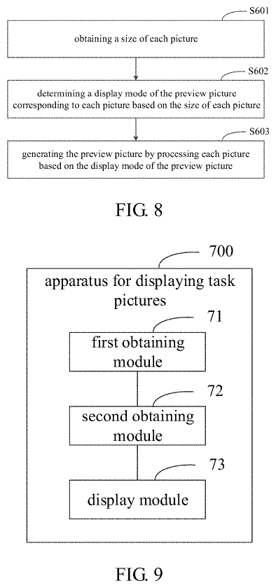

Based on any of the foregoing embodiments, as illustrated in FIG. 8, the preview picture corresponding to the picture is generated by the following method.

In S601, a size of each picture is obtained.

In S602, a display mode of the preview picture corresponding to each picture is determined based on the size of each picture.

In the embodiment of the present disclosure, considering the influence of the picture size on the display mode of the preview picture, different image sizes may correspond to different display modes of the preview picture.

In specific implementation, a mapping relationship or mapping table between picture sizes and display modes of the preview picture may be established in advance. After the size of each picture is obtained, the required display method of the preview picture may be obtained by querying the mapping relationship or the mapping table.

It should be noted that the above-mentioned mapping relationship or mapping table may be calibrated according to actual conditions and set in the storage space of the server in advance.

In S603, each picture is processed based on the display mode of the preview picture to generate the preview picture.

Therefore, considering the influence of the picture size on generating the preview picture, the display mode of the preview picture in the method may be determined based on the picture size, and each picture is processed based on the display mode to generate the preview picture corresponding to the picture.

Further, determining the display mode of the preview picture corresponding to each picture based on the size of each picture in S602 may include some possible implementation manners.

In some embodiments, a display mode in a second preset picture box is determined as the display mode of the preview picture when the size of each picture meets any one of the following three conditions.

(1) the width of each picture is equal to or less than a preset second width threshold and the height of each picture is equal to or less than a preset second height threshold.

(2) the width of each picture is equal to or less than the second width threshold and the height of each picture is greater than a maximum height of a preview window.

(3) the width of each picture is greater than a maximum width of the preview window and the height of each picture is equal to or less than the second height threshold.

In the embodiment of the present disclosure, a size of the preview window may be greater than the size of the second preset picture box, for example, the preview window may be a display screen of a terminal device. The terminal device may be a mobile terminal, a computer, etc.

The second width threshold, the second height threshold, the maximum width of the preview window, the maximum height of the preview window, and the width and height of the second preset picture box may be set according to the actual situation, and are preset in the storage space of the server in advance. For example, the second width threshold, the second height threshold, and the width and height of the second preset picture box can all be set to 100 px.

In the embodiment of the present disclosure, when the size of each picture meets any one of the above three conditions, it indicates that the width and/or height of each picture is small, the display mode in the second preset picture box may be determined as the display mode of the preview picture a display rule for the minimum size. The display mode in the second preset picture box refers to a display mode where the preview picture is displayed in the second preset picture box and a display area of the preview picture does not exceed the second preset picture box. The specific display mode is not limited here.

It may be understood that, for the preview picture obtained by the display mode in the second preset picture box, its width is less than or equal to the width of the width of the second preset picture box and its height is less than or equal to the height of the second preset picture box.

Further, when the display mode of the preview picture is the display mode in the second preset picture box, processing each picture based on the display mode of the preview picture to generate the preview picture in S603 may include three possible implementation manners below.

As a first possible implementation manner, when the width of each picture is equal to or less than the second width threshold and the height of each picture is equal to or less than the second height threshold, each picture is displayed in the second preset picture box in a horizontally and vertically centered manner to generate the preview picture.

It should be noted that the width of the second preset picture box is the second width threshold and the height of the second preset picture box is the second height threshold.

In the embodiments of the present disclosure, when the width of each picture is equal to or less than the second width threshold and the height of each picture is equal to or less than the second height threshold, it indicates that the width of each picture is equal to or less than the width of the second preset picture box and the height of each picture is also equal to or less than the height of the second preset picture box, the width and height of each picture may be kept unchanged at this time, and each picture is displayed in the second preset picture box in a horizontal and vertical centering manner to generate the preview picture corresponding to the picture.

As a second possible implementation manner, when the width of each picture is equal to or less than the second width threshold and the height of each picture is greater than the maximum height of the preview window, two ends of each picture is symmetrically truncated in a height direction based on the second height threshold, and the truncated picture is displayed in the second preset picture box in a horizontally and vertically centered manner to generate the preview picture.

In the embodiment of the present disclosure, when the width of each picture is equal to or less than the second width threshold and the height of each picture is greater than the maximum height of the preview window, it indicates that the width of each picture is equal to or less than the width of the second preset picture box and the height of each picture is large, two ends of each picture at this time may be truncated symmetrically in the height direction based on the second height threshold at this time, so that the height of the truncated picture is less than or equal to the second height threshold while maintaining the width of each picture unchanged, and the truncated picture is displayed in the second preset picture box in a horizontally and vertically centered manner to generate the preview picture corresponding to the picture.

It should be noted that, the specific implementation and principle of symmetrically truncating two ends of each picture in the height direction based on the second height threshold, reference may be made to the detailed description in the foregoing embodiment, which will not be repeated here.

As a third possible implementation manner, when the width of each picture is greater than the maximum width of the preview window and the height of each picture is equal to or less than the second height threshold, two ends of each picture in the width direction is truncated symmetrically based on the second width threshold, and the truncated picture in the second preset picture box in a horizontally and vertically centered manner to generate the preview picture.

In the embodiment of the present disclosure, when the width of each picture is greater than the maximum width of the preview window and the height of each picture is equal to or less than the second height threshold, it indicates that the width of each picture is large and the height of each picture is equal to or less than the second preset picture box, two ends of each picture at this time in the width direction may be truncated symmetrically based on the second width threshold, so that the width of the truncated picture is less than or equal to the second width threshold while maintaining the height of the picture unchanged, and the truncated picture is displayed in the second preset picture box in a horizontally and vertically centered manner to generate the to generate the preview picture corresponding to the picture.

It should be noted that, the specific implementation and principle of symmetrically truncating two ends of each picture in the width direction based on the second width threshold, reference may be made to the detailed description in the foregoing embodiment, which will not be repeated here.

In some embodiments a display mode in the preview window based on an original size is determined as the display mode of the preview picture when the size of each picture meets any one of the following two conditions.

(1) the width of each picture is equal to or less than the second width threshold and the height of each picture is greater than the second height threshold and less than the maximum height of the preview window.

(2) the width of each picture is greater than the second width threshold and equal to or less than the maximum width of the preview window and the height of each picture is equal to or less than the maximum height of the preview window.

The display mode in the original size refers to a display mode where the picture is directly displayed with its original size.

Further, when the display mode of the preview picture is the display mode in the original size, processing each picture based on the display mode of the preview picture to generate the preview picture in S603 may include determining the picture as the preview picture.

In some embodiments a display mode in the preview window based on truncation processing is determined as the display mode of the preview picture when the size of a picture meets any one of the following two conditions.

(1) the width of the picture is greater than the maximum width of the preview window and the height of each picture is greater than the second height threshold and less than the maximum height of the preview window.

(2) the width of the picture is greater than the second width threshold and equal to or less than the maximum width of the preview window and the height of each picture is greater than the maximum height of the preview window.

Further, when the display mode of the preview picture is the display mode in the preview window based on truncation processing, processing each picture based on the display mode of the preview picture to generate the preview picture in S603 may include three possible implementation manners below.

As a first possible implementation manner, when the width of the picture is greater than the maximum width of the preview window and the height of each picture is greater than the second height threshold and equal to or less than the maximum height of the preview window, two ends of the picture are symmetrically truncated in a width direction based on the maximum width, and the truncated picture is displayed in the preview window in a horizontally and vertically centered manner to generate the preview picture.

In the embodiment of the present disclosure, when the width of the picture is greater than the maximum width of the preview window and the height of each picture is greater than the second height threshold and equal to or less than the maximum height of the preview window, it indicates that the width is large, two ends of the picture may be truncated symmetrically in the width direction based on the maximum width, so that the width of the truncated picture is less than or equal to the maximum width while maintaining the height of the picture unchanged, and the truncated picture is displayed in the preview window in a horizontally and vertically centered manner to generate the preview picture corresponding to the picture.

It should be noted that, the specific implementation and principle of symmetrically truncating two ends of each picture in the width direction based on the s maximum width, reference may be made to the detailed description in the foregoing embodiment, which will not be repeated here.

As a second possible implementation manner, when the width of each picture is greater than the second width threshold and equal to or less than the maximum width of the preview window and the height of each picture is greater than the maximum height of the preview window, two ends of each picture in the height direction are truncated symmetrically based on the maximum height, and the truncated picture is displayed in the preview window in a horizontally and vertically centered manner to generate the preview picture.

In the embodiment of the present disclosure, when the width of each picture is greater than the second width threshold and equal to or less than the maximum width of the preview window and the height of each picture is greater than the maximum height of the preview window, it indicates that the height of the picture is large, two ends of the picture at this time in the height direction may be truncated symmetrically based on the maximum height, so that the height of the truncated picture is less than or equal to the maximum height while maintaining the width of the picture unchanged, and the truncated picture is displayed in the preview window in a horizontally and vertically centered manner to generate the to generate the preview picture corresponding to the picture.

It should be noted that, the specific implementation and principle of symmetrically truncating two ends of the picture in the height direction based on the maximum height, reference may be made to the detailed description in the foregoing embodiment, which will not be repeated here.

In some embodiments: a display mode in a second fixed aspect ratio is determined as the display mode of the preview picture when the width of each picture is greater than the maximum width of the preview window and the height of each picture is greater than the maximum height of the preview window.

In the embodiment of the present disclosure, when the width of each picture is greater than the maximum width of the preview window and the height of each picture is greater than the maximum height of the preview window, it indicates that the width and height of each picture are both large, the display mode in the second fixed aspect ratio may be determined as the display mode of the preview picture. The display mode in the second fixed aspect ratio refers to a display mode where the aspect ratio of the preview picture is consistent with the aspect ratio of the picture.

Further, when the method for generating the preview picture is the display mode in the second fixed aspect ratio, processing each picture based on the display mode of the preview picture to generate the preview picture in S603 may include compressing the height and width of each picture in the same compression ratio to generate the preview picture, in which the width of the preview picture is the maximum width of the preview window.

At this time, the calculation method of the compression ratio p is as follows:

$$p = \frac{picture width}{maximum width of the preview window}$$

Therefore, the width of the preview picture obtained by this method is the maximum width of the preview window, and the aspect ratio of the preview picture is consistent with the aspect ratio of the picture.

Based on any of the foregoing embodiments, the first or second preset picture box includes an outer border with a preset thickness and a preset border color, and a background color in the first or second preset picture box is a default background color. The thickness and the border color of the outer border as well as the default background color may all be calibrated according to actual conditions and set in the storage space of the server in advance. For example, the thickness of the outer border may be calibrated to 1 px, the border color may be calibrated to gray (#BCBCBC), and the default background color may be calibrated to white (#F5F5F5).

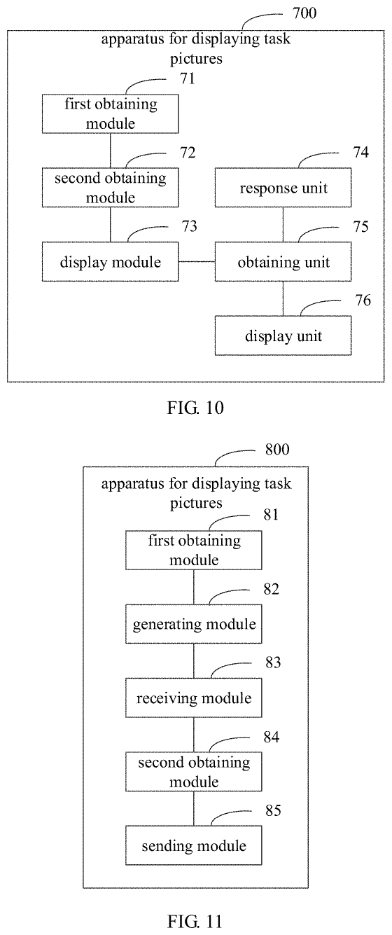

FIG. 9 is a block diagram illustrating an apparatus for displaying task pictures according to an example embodiment. Referring to FIG. 9, the apparatus 700 for displaying task pictures includes: a first obtaining module 71, a second obtaining module 72, and a display module 73. The first obtaining module 71 is configured to execute obtaining an instruction of displaying a task list page. The second obtaining module 72 is configured to execute obtaining a name for each task of at least one task to be displayed and at least one thumbnail corresponding to each task from a server based on the instruction of displaying the task list page. The at least one thumbnail is generated by the server based on at least one picture associated with each task. The display module 73 is configured to execute displaying the name and the at least one thumbnail for each task at a display position corresponding to each task on the task list page.

In an embodiment of the present disclosure, referring to FIG. 10, the apparatus 700 for displaying task pictures further includes: a response unit 74, an obtaining unit 75 and a displaying unit 76. The response unit 74 is configured to execute generating a viewing instruction in response to viewing operations on the at least one thumbnail. The obtaining unit 75 is configured to execute obtaining a preview picture corresponding to the at least one thumbnail from the server based on the viewing instruction. The preview picture is generated by the server based on a picture corresponding to the at least one thumbnail. The display unit 76 is configured to execute displaying the preview picture.

The apparatus for displaying task pictures according to the present disclosure may display task thumbnails on the task list page. Compared to only displaying the picture corresponding to the task on the task detail page in the related art, the user may obtain the task thumbnails on the task list page without entering into the task detail page again, which reduces a number of times of interactions and interaction duration for the user to obtain the pictures. Furthermore, the efficiency of obtaining the pictures is high based on the advantages of small space occupation and fast speed loading of the thumbnails, and the user's experience is improved.

FIG. 11 is a block diagram illustrating another apparatus for displaying task pictures according to an example embodiment. Referring to FIG. 11, the apparatus 800 for displaying task pictures includes: a first obtaining module 81, a generating module 82, a receiving module 83, a second obtaining module 84, and a sending module 85. The first obtaining module 81 is configured to execute obtaining at least one picture associated with each task in a task list page. The generating module 82 is configured to execute generating a thumbnail corresponding to each picture in the at least one picture. The receiving module 83 is configured to execute receiving an instruction of displaying a task list page sent by a client terminal. The second obtaining module 84 is configured to execute obtaining a name for each task of at least one task to be displayed and at least one thumbnail corresponding to each task from a server based on the instruction of displaying the task list page. The sending module 85 is configured to execute sending the name and the at least one thumbnail for each task of at least one task to the client terminal, so that the client terminal displays the name and the at least one thumbnail for each task at a display position corresponding to each task in the task list page.

In an embodiment of the present disclosure, the generating module 82 is further configured to execute: obtaining a size of each picture; determining a display mode of the thumbnail corresponding to each picture based on the size of each picture; and processing each picture based on the display mode of the thumbnail, to generate the thumbnail.

In an embodiment of the present disclosure, the size of each picture includes a width and a height of each picture, and the generating module 82 is further configured to execute: when the width of each picture is equal to or less than a preset first width threshold or the height of each picture is equal to or less than a preset first height threshold, determining a display mode in a first preset picture box as the display mode of the thumbnail, in which a width of the first preset picture box is the first width threshold and a height of the first preset picture box is the first height threshold; and when the width of each picture is greater than the first width threshold and the height of each picture is equal to or less than the first height threshold, determining a display mode in a first fixed aspect ratio as the display mode of the thumbnail.

In an embodiment of the present disclosure, the generating module 82 is further configured to execute: when the width of each picture is equal to or less than the first width threshold or the height of each picture is equal to or less than the first height threshold, displaying each picture in the first preset picture box in a horizontally and vertically centered manner to generate the thumbnail; when the width of each picture is greater than the first width threshold and the height of each picture is equal to or less than the first height threshold, symmetrically truncating two ends of each picture in a width direction based on the first width threshold and displaying the truncated picture in the first preset picture box in a horizontally and vertically centered manner to generate the thumbnail; and when the width of each picture is equal to or less than the first width threshold and the height of each picture is greater than the first height threshold, symmetrically truncating two ends of each picture in a height direction based on the first height threshold and displaying the truncated picture in the first preset picture box in a horizontally and vertically centered manner to generate the thumbnail.

In an embodiment of the present disclosure, the generating module 82 is further configured to execute: compressing the height and width of each picture in the same compression ratio to generate the thumbnail, in which the height of the thumbnail is equal to the first height threshold.

In an embodiment of the present disclosure, the apparatus further includes: the first obtaining module 81, the receiving module 83, the second obtaining module 84 and the sending module 85. The first obtaining module 81 is further configured to execute pre-storing a preview picture corresponding to each picture in the at least one picture. The receiving module 83 is further configured to execute receiving a viewing instruction of the thumbnail sent by the client terminal. The second obtaining module 84 is further configured to execute obtaining the preview picture corresponding to the thumbnail based on the view instruction of the thumbnail. The sending module 85 is further configured to execute sending the preview picture corresponding to the thumbnail to the client terminal, so that the client terminal displays the preview picture corresponding to the thumbnail.

In an embodiment of the present disclosure, the generating module 82 is further configured to execute: obtaining a size of each picture; determining a display mode of the preview picture corresponding to each picture based on the size of each picture; and processing each picture based on the display mode of the preview picture to generate the preview picture.

In an embodiment of the present disclosure, the generating module 82 is further configured to execute: determining a display mode in a second preset picture box as the display mode of the preview picture when the size of each picture meets any one of the following three conditions: the width of each picture is equal to or less than a preset second width threshold and the height of each picture is equal to or less than a preset second height threshold, the width of each picture is equal to or less than the second width threshold and the height of each picture is greater than a maximum height of a preview window, the width of each picture is greater than a maximum width of the preview window and the height of each picture is equal to or less than the second height threshold, in which a width of the second preset picture box is the second width threshold and a height of the second preset picture box is the second height threshold; determining a display mode in an original size as the display mode of the preview picture when the size of each picture meets any one of the following two conditions: the width of each picture is equal to or less than the second width threshold and the height of each picture is greater than the second height threshold and less than the maximum height of the preview window, the width of each picture is greater than the second width threshold and equal to or less than the maximum width of the preview window and the height of each picture is equal to or less than the maximum height of the preview window; and determining a display mode in a second fixed aspect ratio as the display mode of the preview picture when the width of each picture is greater than the maximum width of the preview window and the height of each picture is greater than the second height threshold.

In an embodiment of the present disclosure, the generating module 82 is further configured to execute: when the width of each picture is equal to or less than the second width threshold and the height of each picture is equal to or less than the second height threshold, displaying each picture in the second preset picture box in a horizontally and vertically centered manner to generate the preview picture; when the width of each picture is equal to or less than the second width threshold and the height of each picture is greater than the maximum height of the preview window, symmetrically truncating two ends of each picture in a height direction based on the second height threshold and displaying the truncated picture in the second preset picture box in a horizontally and vertically centered manner to generate the preview picture; and when the width of each picture is greater than the maximum width of the preview window and the height of each picture is equal to or less than the second height threshold, symmetrically truncating two ends of each picture in a width direction based on the second width threshold and displaying the truncated picture in the second preset picture box in a horizontally and vertically centered manner to generate the preview picture.

In an embodiment of the present disclosure, the generating module 82 is further configured to execute: determining each picture as the preview picture.

In an embodiment of the present disclosure, the generating module 82 is further configured to execute: compressing the height and width of each picture in the same compression ratio to generate the preview picture, in which the width of the preview picture is the maximum width of the preview window.

In an embodiment of the present disclosure, the first preset picture box or the second preset picture box includes an outer border with a preset thickness and a preset border color, and a background color in the first preset picture box or the second preset picture box is a default background color.

The apparatus for displaying task pictures according to the present disclosure may generate the thumbnails corresponding to the pictures, receive the instruction of displaying the task list page sent by the client terminal and send the name and the at least one thumbnail for each task of at least one task to the client terminal, so that the client terminal displays the thumbnails of the task on the task list page. Compared with only displaying the thumbnails corresponding to the task on a task detail page in the related art, the user may obtain the thumbnails of the task on the task list page without entering the task detail page again, which reduces the number of interactions and the interaction duration of obtaining pictures. Further, based on the advantages of small space occupation and fast loading speed of thumbnails, the efficiency of obtaining pictures is high and the user experience is improved.

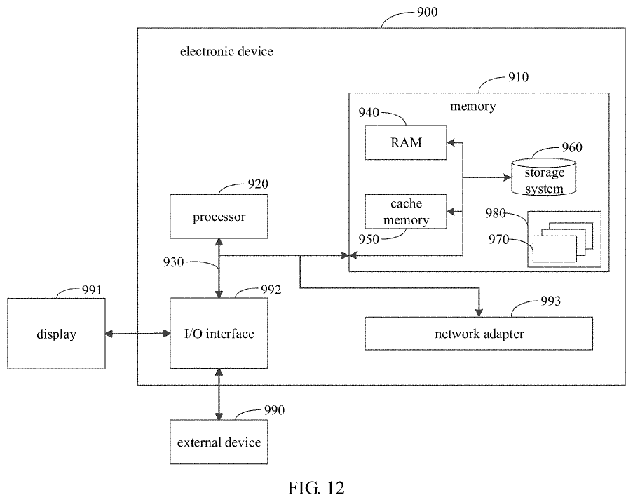

FIG. 12 is a block diagram illustrating an electronic device according to an example embodiment. The electronic device 900 may also be a server.

As illustrated in FIG. 12, the foregoing electronic device 900 includes: a memory 910, a processor 920, a bus 930 for connecting different components (including the memory 910 and the processor 920). The memory 910 has computer programs stored thereon. When the processor 920 executes the programs, the method for displaying task pictures described in the embodiment of the present disclosure is implemented.

The bus 930 represents one or more of several types of bus structures, including a memory bus or a memory controller, a peripheral bus, a graphics acceleration port, a processor, or a local bus using any bus structure from multiple bus structures. For example, the architectures include, but are not limited to, an industry standard architecture (ISA) bus, a microchannel architecture (MAC) bus, an enhanced ISA bus, a video electronics standards association (VESA) local bus, and a peripheral component interconnection (PCI) bus.

The electronic device 900 typically includes a variety of electronic device-readable media that may be any available media that may be accessed by the server 800, including volatile and non-volatile media, removable and non-removable media.

The memory 910 may also include a computer system readable medium in the form of a volatile memory, such as a random access memory (RAM) 940 and/or a cache memory 950. The electronic device 900 may further include other removable/non-removable, volatile/nonvolatile computer system storage media. For example only, the storage system 960 may be used to read and write non-removable, non-volatile magnetic media (not illustrated in FIG. 12, and is generally referred to as a “hard drive”). Although not illustrated in FIG. 12, a disk drive for reading and writing a removable non-volatile disk (such as a “floppy disk”) and an optical disc drive for reading and writing a removable non-volatile disk (such as CD-ROM, DVD-ROM or other optical media)) may be provided. In these cases, each drive may be connected to the bus 930 through one or more data medium interfaces.

The memory 910 may include at least one program product having a set of (for example, at least one) program modules. The program modules are configured to perform the functions of the embodiments of the present disclosure.

A program/utility tool 980 having a set of (at least one) program modules 970 may be stored in, for example, the memory 910. Such program module 970 includes, but is not limited to, an operating system, one or more application programs, and other programs modules and program data, each of these examples or some combination may include the implementation of a network environment. The program module 970 generally executes the functions and/or methods in the embodiments described in the present disclosure.

The electronic device 900 may also communicate with one or more external devices 990 (such as a keyboard, a pointing device, a display 991, etc.), and may also communicate with one or more devices that enable a user to interact with the electronic device 900, and/or any device (such as a network card, modulator-demodulator, etc.) that enables the electronic device 900 to communicate with one or more other computing devices. Such communication may be performed through an input/output (I/O) interface 992. In addition, the electronic device 900 may also communicate with one or more networks (for example, a local area network (LAN), a wide area network (WAN), and/or a public network, such as the Internet) through a network adapter 993. As illustrated in FIG. 12, the network adapter 993 communicates with other modules of the electronic device 900 through the bus 930. It should be understood that although not illustrated in FIG. 12, other hardware and/or software modules may be used in conjunction with the electronic device 900, including but not limited to: microcode, device drivers, redundant processing units, external disk drive arrays, RAID systems, tape drives and data backup storage systems, etc.

The processor 920 executes various function applications and data processing by running programs stored in the memory 910.

It should be noted that, the implementation and technical principle of the server in the embodiments refers to the foregoing explanation of the method for displaying task pictures in the embodiments of the present disclosure, which are not repeated here.

The electronic device according to the present disclosure may display task thumbnails on the task list page. Compared to only displaying the thumbnails corresponding to the task on a task detail page in the related art, the user may obtain the thumbnails of the task on the task list page without entering the task detail page again, which reduces the number of interactions and the interaction duration of obtaining pictures. Further, based on the advantages of small space occupation and fast loading speed of thumbnails, the efficiency of obtaining pictures is high and the user experience is improved.

In order to implement the above-mentioned embodiments, the present disclosure also provides a storage medium. When instructions in the storage medium are executed by a processor of an electronic device or a server, the electronic device is caused to execute the method for displaying task pictures as described above, or the server is caused to execute the method for displaying task pictures as described above.

In order to implement the above-mentioned embodiments, the present disclosure also provides a computer program product. When the computer program is executed by a processor of an electronic device or a server, the electronic device is caused to execute the method for displaying task pictures as described above, or the server is caused to execute the method for displaying task pictures as described above.

What is claimed is:

1. A method for displaying task pictures, comprising:
obtaining an instruction of displaying a task list page;
obtaining a name for each task of at least one task to be displayed and at least one thumbnail corresponding to each task from a server based on the instruction of displaying the task list page, wherein the at least one thumbnail is generated by the server based on at least one picture associated with each task; and
displaying the name and the at least one thumbnail for each task at a display position corresponding to each task on the task list page.

2. The method of claim 1, further comprising:
generating a viewing instruction in response to viewing operations on the at least one thumbnail;
obtaining a preview picture corresponding to the at least one thumbnail from the server based on the viewing instruction, wherein the preview picture is generated by the server based on a picture corresponding to the at least one thumbnail; and
displaying the preview picture.

3. A method for displaying task pictures, comprising:
obtaining at least one picture associated with each task in a task list page;
generating a thumbnail corresponding to each picture in the at least one picture;
receiving an instruction of displaying a task list page sent by a client terminal;
obtaining a name for each task of at least one task to be displayed and at least one thumbnail corresponding to each task from a server based on the instruction of displaying the task list page; and
sending the name and the at least one thumbnail for each task of at least one task to the client terminal, so that the client terminal displays the name and the at least one thumbnail for each task at a display position corresponding to each task in the task list page.

4. The method of claim 3, wherein generating the thumbnail corresponding to each picture comprises:
obtaining a size of each picture;
determining a display mode of the thumbnail corresponding to each picture based on the size of each picture; and
generating the thumbnail corresponding to each picture by processing each picture based on the display mode of the thumbnail.

5. The method of claim 4, wherein the display mode of the thumbnail corresponding to a picture comprises any one or more of:
a first display mode based on the size of the picture;
a second display mode based on truncation processing of the picture; and
a third display mode based on compression processing of the picture in a first fixed aspect ratio.

6. The method of claim 5, wherein the first display mode comprises:
displaying the thumbnail in a first preset picture box in a horizontally and vertically centered manner.

7. The method of claim 5, wherein determining the display mode of the thumbnail corresponding to a picture as the first display mode in response to the size of the picture being equal to or less than a size of a first preset picture box.

8. The method of claim 5, wherein determining the display mode of the thumbnail corresponding to a picture as the second display mode in response to the size of the picture being greater than a size of a first preset picture box in either a length direction or a width direction.

9. The method of claim 5, wherein determining the display mode of the thumbnail corresponding to a picture as the third display mode in response to the size of the picture being greater than a size of a first preset picture box in both a length direction and a width direction.

10. The method of claim 3, wherein a preview picture corresponding to each picture in the at least one picture is pre-stored, and the method further comprises:
receiving a viewing instruction of the thumbnail sent by the client terminal;
obtaining the preview picture corresponding to the thumbnail based on the view instruction of the thumbnail; and
sending the preview picture corresponding to the thumbnail to the client terminal, so that the client terminal displays the preview picture corresponding to the thumbnail.

11. The method of claim 10, wherein generating the preview picture corresponding to each picture comprises:
obtaining a size of each picture;
determining a display mode of the preview picture corresponding to each picture based on the size of each picture; and
generating the preview picture corresponding to each picture by processing each picture based on the display mode of the preview picture.

12. The method of claim 11, wherein the display mode of the preview picture corresponding to a picture comprises any one or more of:
a first display mode based on the size of the picture;
a second display mode based on truncation processing of the picture; and
a third display mode based on compression processing of the picture in a second fixed aspect ratio.

13. The method of claim 12, wherein the first display mode comprises:
displaying the preview picture in a second preset picture box or in a preview window in a horizontally and vertically centered manner, wherein a size of the preview window is greater than a size of the second preset picture box.

14. The method of claim 12, wherein determining the display mode of the preview picture corresponding to a picture as the first display mode in response to the size of the picture being equal to or less than a size of a preview window.

15. The method of claim 12, wherein determining the display mode of the preview picture corresponding to a picture as the second display mode in response to the size of the picture being greater than a size of a preview window in either a length direction or a width direction.

16. The method of claim 12, wherein determining the display mode of the preview picture corresponding to a picture as the third display mode in response to the size of the picture being greater than a size of a preview window in both a length direction and a width direction.

17. An apparatus for displaying task pictures, comprising:
a processor; and
a memory for storing instructions executable by the processor;
wherein the processor is configured to:
obtain at least one picture associated with each task in a task list page;
generate a thumbnail corresponding to each picture in the at least one picture;
receive an instruction of displaying a task list page sent by a client terminal;
obtain a name for each task of at least one task to be displayed and at least one thumbnail corresponding to each task from a server based on the instruction of displaying the task list page; and
send the name and the at least one thumbnail for each task of at least one task to the client terminal, so that the client terminal displays the name and the at least one thumbnail for each task at a display position corresponding to each task in the task list page.

18. The apparatus of claim 17, wherein the processor is further configured to:
obtain a size of each picture;
determine a display mode of the thumbnail corresponding to each picture based on the size of each picture; and
generate the thumbnail corresponding to each picture by processing each picture based on the display mode of the thumbnail.

19. The apparatus of claim 18, wherein the display mode of the thumbnail corresponding to a picture comprises any one or more of:
a first display mode based on the size of the picture;
a second display mode based on truncation processing of the picture; and
a third display mode based on compression processing of the picture in a first fixed aspect ratio.

20. The apparatus of claim 19, wherein the first display mode comprises:
displaying the thumbnail in a first preset picture box in a horizontally and vertically centered manner.
